(19) United States
(12) Patent Application Publication
(10) Pub. No.: US 2019/0108798 A1
(43) Pub. Date: Apr. 11, 2019

(54) COLOR IMAGE DISPLAY DEVICE AND COLOR IMAGE DISPLAY METHOD

(71) Applicant: SHARP KABUSHIKI KAISHA, Sakai City, Osaka (JP)

(72) Inventor: TOMOYUKI ISHIHARA, Sakai City (JP)

(21) Appl. No.: 16/087,081

(22) PCT Filed: Mar. 16, 2017
(86) PCT No.: PCT/JP2017/010746

§ 371 Date: Sep. 20, 2018

(30) Foreign Application Priority Data
Mar. 23, 2016 (JP) 2016-058416

(51) Int. Cl. G09G 3/34

(52) U.S. Cl. CPC G09G 3/3413; G02B 6/0068

(57) ABSTRACT

The present invention provides a field-sequential color image display device suppressing color breakup and an increase in power consumption. The liquid crystal display device displays a color image by a field-sequential system in which each frame period includes four field periods corresponding to four colors, white, blue, green, and red, and the liquid crystal display device includes a light source portion which includes blue, green, and red LEDs, and a light source driver circuit. The light source driver circuit generates blue, green, and red light source control signals CswB, CswG, and CswR, and drives the light source portion on the basis of these signals. At this time, the light source driver circuit generates the light source control signals CswB, CswG, and CswR such that the blue, green, and red LEDs emit light sequentially during an ON period Tₒₙ within a white field period Tw, and respective emission periods for the colors occur symmetrically with respect to the axis of symmetry at the midpoint of the ON period Tₒₙ in the direction of time.

### TECHNICAL FIELD

The present invention relates to color image display devices, mote specifically to a color image display device, such as a liquid crystal display device, which displays a color image by a field-sequential system.

### BACKGROUND ART

Most liquid crystal display devices that display color images include color filters respectively transmitting red (R), green (G), and blue (B) light therethrough, the filters being provided for each set of three subpixels into which each pixel is divided. However, about ⅔ of the backlight that illuminates a liquid crystal panel is absorbed by the color filters, and therefore such a liquid crystal display device using color filters has low light-use efficiency. Accordingly, field-sequential liquid crystal display devices, which achieve display in colors without using color filters, are drawing attention.

In the case of a typical field-sequential liquid crystal display device, one frame period, which is a display period for one screen, is divided into three field periods, namely, first, second, and third field periods (the “field period” is also referred to as the “subframe period”). While the back of the liquid crystal panel is irradiated with red, green, and blue source light during the first, second, and third field periods, a red image in accordance with a red component of an input image signal, is displayed during the first field period, a green image in accordance with a green component is displayed during the second field period, and a blue image in accordance with a blue component is displayed during the third field period, with the result that a color image is displayed on the liquid crystal panel.

Such a field-sequential liquid crystal display device can dispense with color filters and therefore has high light-use efficiency when compared to liquid crystal display devices using color filters. Moreover, by employing such a field-sequential system, each pixel is displayed in different colors among the three field periods, which eliminates the need to provide subpixels for the respective colors, making it possible to realize a high-resolution display device. Moreover, since the field-sequential system dispenses with the color filters, it is also possible to realize a transparent display.

However, in the case of the field-sequential display device, when an observer's line of sight to a display screen changes, the observer might perceive time lags in lighting up between primary colors of light sources and see the colors of the fields separately (such a phenomenon is referred to as “color breakup”). In a known method for inhibiting color breakup, at least one of the red, green, and blue components is displayed in two or more fields per frame period. For example, in the case of a field-sequential display device in which one frame period includes white, red, green, and blue field periods for displaying white, red, green, and blue images, respectively, the red image, which is a red component of an image represented by an input image signal, is displayed during red and white field periods, the green image, which is a green component, is displayed during a green field period and the white field period, and the blue image, which is a blue component, is displayed during a blue field period and the white field period.

In relation to the subject matter of: the present application, Patent Document 1 describes a backlight device including self-luminous sources (e.g., LEDs) in the three primary colors, red (R), green (G), and blue (B), and obtaining white light by mixing and synthesizing light from the three primary-color sources, in order to illuminate a liquid crystal display device using a light guide plate and/or a light diffusion plate. In the backlight device, to obtain white light that appears as bright to the human eye as conventional and reduce effective power inputted to the three primary-color sources, thereby achieving lower power consumption and longer lives of the sources, the sources are lit up sequentially at different times for the respective colors such that the colors overlap for some time within the duration of time-division illumination.

### CITATION LIST

### Patent Document

Patent Document 1: Japanese Unexamined Patent Application Publication No. 2004-93761

### SUMMARY OF THE INVENTION

### Problems to be Solved by the Invention

In the case of the field-sequential display device that is configured such that each frame period includes red, green, blue, and white field periods in order to prevent color breakup, the field-sequential display device is normally provided with three light sources, which are red, green, and blue light sources, the red light source emits light during the red field period, the green light source emits light during the green field period, the blue light source emits light, during the blue field period, and all of the three light sources emit light simultaneously during the white field period.

FIG. 14 is a timing chart showing the operation of a backlight device of such a conventional field-sequential liquid crystal display device. In FIG. 14, symbols “Tw”, “Tb”, “Tg”, and “Tr” respectively denote white, blue, green, and red field periods, symbol “Tsc” denotes a scanning period within each field period, in which a liquid crystal panel is scanned to write pixel data for one screen, symbol “T_{off}” denotes a period within each field period, in which the backlight device is in OFF state, symbol “Tₒₙ” denotes a period within each field period, in which the backlight device is ON state, waveforms LED-B, LED-G, and LED-R represent ON/OFF of the blue, green, and red light sources, respectively, of the backlight device (high levels correspond to ON states), and waveform Pbl represents a change of power consumption of the backlight device. As is apparent from FIG. 14, during the white field period Tw, since the blue, green, and red light sources emit light simultaneously, power consumed by the backlight device increases significantly compared to during the other field periods Tb, Tg, and Tr. This leads to a larger power supply circuit and a larger radiation mechanism, resulting in increased cost of the display device.

Therefore, an objective of the present invention is to provide a field-sequential color image display device suppressing color breakup and an increase in power consumption.

### Solution to the Problems

A first aspect of the present invention provides a color image display device of a field-sequential system with each frame period including a predetermined number of field periods respectively corresponding to a predetermined number of colors including white, the predetermined number being four or more, the device including:

a light source portion including first to third light sources respectively emitting light in first to third colors constituting three primary colors;

a spatial light modulation portion configured to transmit or reflect light from the light source portion;

a light source driver circuit configured to selectively drive the first to third light sources so as to obtain light in colors respectively corresponding to the predetermined number of field periods during the respective field periods; and

a spatial light modulation portion driver circuit configured to control transmittance through or reflectance of the spatial light modulation portion such that images are displayed in the colors respectively corresponding to the predetermined number of field periods during the respective field periods, wherein,

the light source driver circuit drives the first to third light sources such that at least two of the first to third light sources emit light sequentially during a white field period being one of the predetermined number of field periods and corresponding to white.

A second aspect of the present invention provides the color image display device according to the first aspect of the present invention, wherein the light source driver circuit drives the first to third light sources such that respective emission periods of the first to third light sources occur symmetrically in a direction of time during a predetermined period within the white field period.

A third aspect of the present invention provides the color image display device according to the first or second aspect of the present invention, wherein the light source driver circuit drives the first to third light sources such that the first to third light sources emit, light sequentially during the white field period.

A fourth aspect of the present invention provides the color image display device according to the first or second aspect of the present invention, wherein the light source driver circuit drives the first to third light sources such that adjacent emission periods of the first to third light sources overlap within the white field period.

A fifth aspect of the present invention provides the color image display device according to the fourth aspect of the present invention, wherein the light source driver circuit drives the first to third light sources such that the overlapping of the adjacent emission periods of the first to third light sources during the white field period is shorter than a half of each of the adjacent emission periods.

A sixth aspect of the present invention provides the color image display device according to the fourth aspect of the present invention, wherein an emission overlap ratio is defined as a ratio of a sum of periods during which the adjacent emission periods overlap to the white field period and the emission overlap ratio is greater than zero but less than or equal to a predetermined upper limit.

A seventh aspect of the present invention provides the color image display device according to the sixth aspect of the present invention, wherein the emission overlap ratio is approximately less than or equal to 20%.

A eighth aspect of the present invention provides the color image display device according to any one of the second through seventh aspects of the present invention, wherein the spatial light modulation portion is a liquid crystal panel.

A ninth aspect of the present invention provides the color image display device according to the first or second aspect of the present invention, wherein,

the three primary colors are red, green, and blue, and

the light source driver circuit: drives the first to third light sources such that during the white field period, a blue-light emission period occurs first and a green-light emission period occurs second.

A tenth aspect of the present invention provides the color image display device according to the first or second aspect of the present invention, wherein the light source driver circuit drives the first to third light sources such that emission periods of two of the first to third light sources coincide with each other during the white field period or the emission period of one of the two light sources includes the emission period of the other light source.

A eleventh aspect of the present invention provides a color image display method for a color image display device to display an image by a field-sequential system with each frame period including a predetermined number of field periods respectively corresponding to a predetermined number of colors including white, the predetermined number being four or more, the device including a light source portion including first to third light sources respectively emitting light in first to third colors constituting three primary colors, and a spatial light modulation portion configured to transmit or reflect light from the light source portion, the method including:

a light source driving step of selectively driving the first to third light sources so as to obtain light in colors respectively corresponding to the predetermined number of field periods during the respective field periods; and

a spatial light modulation portion driving step of controlling transmittance through or reflectance of the spatial light modulation portion such that images are displayed in the colors respectively corresponding to the predetermined number of field periods during the respective field periods, wherein,

in the light source driving step, the first to third light sources are driven such that at least two of the first to third light sources emit light sequentially during a white field period being one of the predetermined number of field periods and corresponding to white.

Other aspects of the present invention are clear from the above description of the first through eleventh aspects of the present invention and from description of each embodiment to be made herein later, and therefore any descriptions thereof will be omitted herein.

### Effect of the Invention

In the first aspect of the invention, since at least two of the first to third light sources emit light sequentially during the white field period, power consumed by the light source portion generating white light is reduced. Thus, in the case of the field-sequential liquid crystal display device, color breakup is prevented by setting the white field period, and the reduced power consumption of the light source portion renders it possible to inhibit a cost increase due to a larger power supply circuit and a larger radiation mechanism.

In the second aspect of the invention, since the respective emission periods of the first to third light sources occur symmetrically in the direction of time during the predetermined period within the white field period, it is possible to suppress an increase in power consumption of the light source portion and inhibit disturbance of color balance due to a transient characteristic of the optical response of the spatial light modulation portion, thereby maintaining satisfactory color reproducibility.

In the third aspect of the invention, since the first to third light sources emit light sequentially during the white field period, power consumed by the light source portion generating white light can be reduced sufficiently.

In the fourth aspect of the invention, since the adjacent emission periods of the first to third light sources overlap during the white field period, it is possible to suppress an increase in power consumption of the light source portion and inhibit emission luminance during the white field period (i.e., white image display luminance) from decreasing.

In the fifth aspect of the invention, since simultaneous light emission by the first to third light sources is avoided, the power consumption of the light source portion has suppressed peaks.

In the sixth aspect of the invention, since the emission overlap ratio during the white field period is greater than zero but lower than or equal to the predetermined upper limit, it is possible to suppress an increase in power consumption of the light source portion and mitigate a decrease in emission luminance during the white field period.

In the seventh aspect of the invention, since the emission overlap ratio during the white field period is approximately less than or equal to 20%, it is possible to suppress an increase in power consumption of the light source portion and avoid a significant decrease of the emission luminance during the white field period.

In the eighth aspect of the invention, the spatial light modulation portion is a liquid crystal panel, which has a slow optical response, but the respective emission periods of the first to third light sources occur symmetrically in the direction of time during the predetermined period within the white field period, whereby it is possible to inhibit disturbance of color balance due to a delay in the optical response of the liquid crystal panel. Thus, it is possible to display a satisfactory color image by the field-sequential system while using the liquid crystal panel as the spatial light modulation portion.

In the ninth aspect of the invention, during the white field period, the blue-light emission period occurs first and the green-light emission period occurs second. Thus, the emission periods occur in temporal order taking account of the difference in influence on color balance among green, blue, and red light, whereby it is possible to further inhibit the disturbance of color balance due to the transient characteristic of the optical response of the spatial light modulation portion.

In the tenth aspect of the invention, the emission pattern during the white field period is such that emission periods of two of the first to third light sources coincide with each other or the emission period of one of the two light sources includes the emission period of the other light source. Thus, the emission luminance during the white field period is enhanced even though the power consumption of the light source portion increases.

Effects of other aspects of the invention are apparent from the effects of the first through tenth aspects of the invention and also from the description of the following embodiments of the invention, and therefore any descriptions thereof will be omitted herein.

### BRIEF DESCRIPTION OF THE DRAWINGS

FIG. 1 is a schematic block diagram illustrating an overall configuration of a liquid crystal display device according to a first embodiment of the present invention.

FIG. 2 provides (A) an oblique view schematically illustrating a first configuration example of a backlight unit in the first embodiment and (B) an oblique view schematically illustrating a second configuration example.

FIG. 3 is a block diagram illustrating a functional configuration of the liquid crystal display device according to the first embodiment.

FIG. 4 is a timing chart for describing the operation of the liquid crystal display device according to the first embodiment.

FIG. 5 is a block diagram illustrating the configuration of a backlight driver circuit in the first embodiment.

FIG. 6 is a timing chart for describing the operation of the backlight unit in the first embodiment.

FIG. 7 is a timing chart for describing a basic operation of the backlight unit during a white field period in the first embodiment.

FIG. 8 is a timing chart for describing the operation (emission pattern) of the backlight, unit during the white field period in the first embodiment.

FIG. 9 is a timing chart for describing a first emission pattern of a backlight unit during a white field period in a second embodiment of the present invention.

FIG. 10 is a taming chart for describing a second emission pattern of the backlight unit during the white field period in the second embodiment.

FIG. 11 is a timing chart for describing the operation of a backlight unit during a white field period in a third embodiment of the present invention.

FIG. 12 is a diagram illustrating a schematic configuration of a projection display device according to another embodiment of the present invention.

FIG. 13 is a block diagram illustrating the configuration of a backlight driver circuit in a variant of the embodiments of the present invention.

FIG. 14 is a timing chart showing the operation of a backlight device of a conventional field-sequential liquid crystal display device.

### MODES FOR CARRYING OUT THE INVENTION

Hereinafter, embodiments of the present invention will be described. In the following, one frame period is a time period for refreshing an image for one screen (i.e., rewriting a display image), and the “one frame period” is assumed to last for the duration of one frame period (16.67 ms) for a typical display device whose refresh rate is 60 Hz, but this is not intended to limit the present invention.

### 1. First Embodiment

<1.1 Overall Configuration>

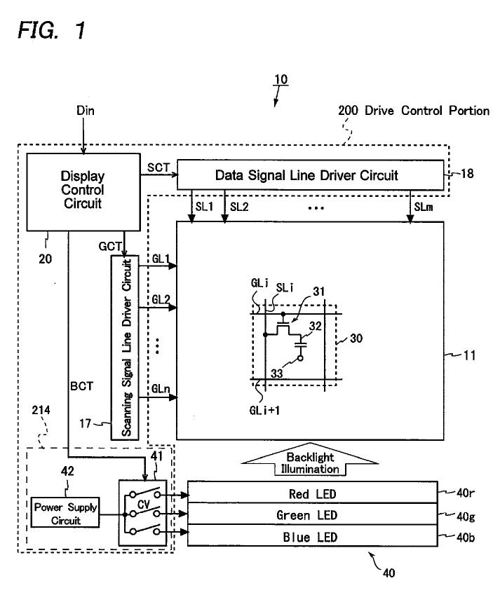

FIG. 1 is a schematic block diagram illustrating an overall configuration of a field-sequential liquid crystal display device according to a first embodiment of the present invention. The liquid crystal display device 10 displays a color image by a field-sequential system in which one frame period is divided into four field periods. The liquid crystal display device 10 includes a liquid crystal panel 11, a display control circuit 20, a scanning signal line driver circuit 17, a data signal line driver circuit 19, a backlight unit 40, and a backlight driver circuit 214 including a lighting control circuit 41 and a power supply circuit 42. Note that the display control circuit 20, the scanning signal line driver circuit 17, the data signal line driver circuit 18, and the backlight driver circuit 214 constitute a drive control portion 200. Moreover, the liquid crystal panel 11 functions as a spatial light modulation portion driven by the scanning signal line driver circuit 17 and the data signal line driver circuit 18 to control transmittance of light from the backlight unit 40 illuminating the back thereof, on a pixel by pixel basis.

The liquid crystal panel 11 includes a plurality of (m) data signal lines SLₗ to SLₘ, a plurality of (n) scanning signal lines GLₗ to GLₙ, and a plurality of (m×n) pixel forming portions 30 provided corresponding to respective intersections of the data signal lines SLₗ to SLₘ and the scanning signal lines GLₗ to GLₘ. Each pixel forming portion 30 includes a TFT 31 which serves as a switching element, a pixel electrode 32 which is connected to a drain terminal of the TFT 31, and a common electrode 33 which, along with the pixel electrode 32, forms a liquid crystal capacitor. The TFT 31 has a gate terminal connected to the scanning signal line GLᵢ (where 1≤i≤n) and a source terminal connected to the data signal line SLⱼ (where 1≤j≤m).

The display control circuit 20 externally receives an input signal Dᵢₙ. The input signal Dᵢₙ includes an input image signal which includes red, green, and blue image signals Rᵢₙ, Gᵢₙ, and Bᵢₙ representing red, green, and blue components, respectively, of an image to be displayed, and the input signal Dᵢₙ also includes a control signal which specifies, for example, timing required for displaying the image represented by the input image signal. On the basis of such an input signal Dᵢₙ, the display control circuit 20 generates a scanning control signal GCT, a data control signal SCT, and a light source portion control signal BCT. The scanning control signal GCT, the data control signal SCT, and the light source portion control signal BCT are respectively provided to the scanning signal line driver circuit 17, the data signal line driver circuit 18, and the backlight driver circuit 214.

The scanning control signal GCT provided to the scanning signal line driver circuit 17 includes, for example, a scanning start pulse signal and a scanning clock signal. In accordance with these signals, the scanning signal line driver circuit 17 applies an active scanning signal sequentially to the scanning signal lines GLₗ to GLₙ. As will be described later, in the present embodiment, on the basis of the inputted red, green, and blue image signals Rᵢₙ, Gᵢₙ, and Bᵢₙ, signals specifying display intensities, which are a white gradation signal Sw, a red gradation signal Sr, an green gradation signal Sg, and a blue gradation signal Sb, are generated, and each frame period Tfr is divided into the following four field periods (see FIGS. 4 and 6): a white field period (also referred to below as a “W-field period”) Tw during which a white image represented by the white gradation signal Sw is displayed; a blue field period (also referred to below as a “B-field period”) Tb during which a blue image represented by the blue gradation signal Sb is displayed; a green field period (also referred to below as a “G-field period”) Tg during which a green image represented by the green gradation signal Sg is displayed; and a red field period (also referred to below as an “R-field period”) Tr during which a red image represented by the red gradation signal Sr is displayed. The scanning signal line driver circuit 7 applies an active scanning signal sequentially to the n scanning signal lines GLₗ to GLₙ during a scanning period Tsc within each of the field periods Tw, Tb, Tg, and Tr.

The data control signal SCT provided to the data signal line driver circuit 18 includes the white, blue, green, and red gradation signals Sw, Sb, Sg, and Sr as optical modulation signals that control light transmittance through each pixel forming portion 30 for use in forming an image to be displayed, and also includes a data start pulse signal, a data clock signal, a latch strobe signal, etc. In accordance with these signals, the data signal line driver circuit 18 activates unillustrated internal components thereof, including a shift register, a sampling latch circuit, etc., with the result that four types of parallel digital signals respectively corresponding to the white, blue, green, and red gradation signals Sw, Sb, Sg, and Sr are sequentially converted to analog signals for respective field periods by an unillustrated D/A conversion circuit, thereby generating m data signals as drive image signals, which are respectively applied to the data signal lines SLₗ to SLₘ. Here, the data signals that represent the white image based on the white gradation signal Sw are applied to the data signal lines SLₗ to SLₘ during the W-field period Tw, the data signals that represent the blue image based on the blue gradation signal Sb are applied during the B-field period Tb, the data signals that represent the green image based on the green gradation signal Sg are applied during the G-field period Tg, and the data signals that represent the red image based on the red gradation signal Sr are applied during the R-field period Tr.

The backlight unit 40 includes red, green, and blue LEDs (light-emitting diodes) 40r, 40g, and 40b which are respectively red, green, and blue light sources arranged one-dimensionally or two-dimensionally. The red, green, and blue LEDs 40r, 40g, and 30b are configured to be connectable independently to the power supply circuit 42 via the lighting control circuit 41.

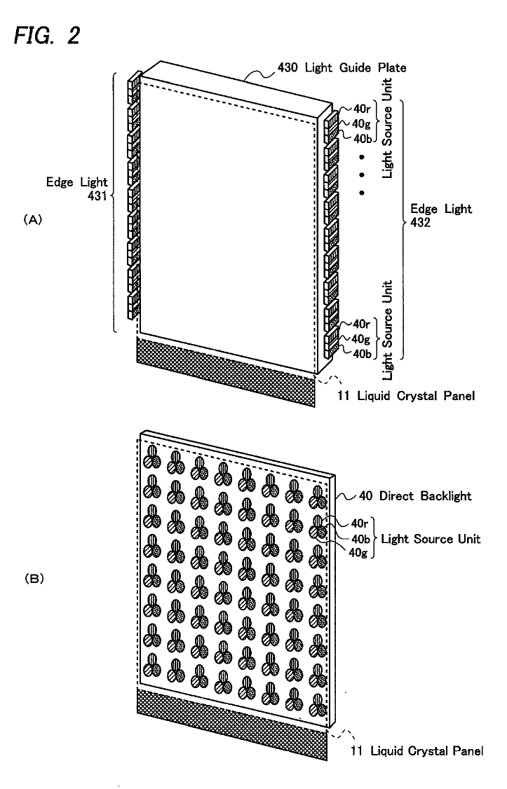

FIG. 2(A) is an oblique view schematically illustrating a first configuration example of the backlight unit 40. In this configuration example, the backlight unit 40 includes a light guide plate 430 disposed so as to face the back of the liquid crystal panel 11, and edge lights 431 and 432 disposed on opposite side surfaces of the light guide plate 430 (such a backlight unit is referred to as an “edge-lit backlight”). Each of the edge lights 431 and 432 is configured by arranging in a line a plurality of sets of light source units, each set consisting of red, green, and blue LEDs 40r, 40g, and 40b. The backlight unit 40 functions as a planar illumination device in which light emitted by the light-emitting diodes 40r, 40g, and 40b enters the light guide plate 430 from the opposite side surfaces and exits the light guide plate 430 from a principal surface to illuminate the back of the liquid crystal panel 11.

FIG. 2(B) is an oblique view schematically illustrating a second configuration example of the backlight unit 40. In this configuration example, the backlight unit 40 is configured by two-dimensionally arranging a plurality of sets of light source units, each set consisting of red, green, and blue LEDs 40r, 40g, and 40b, on the back side of the liquid crystal panel 11 (such a backlight unit is referred to as a “direct backlight”). The backlight unit. 40 functions as a planar illumination device in which the LEDs 40r, 40g, and 40b in the two-dimensionally arranged light source units emit light to illuminate the back of the liquid crystal panel 11.

The light source portion control signal BCT provided to the backlight driver circuit 214 by the display control circuit 20 includes a field-specifying signal, specifically, a field designation signal Cft, which indicates that the current field period is the W-field, B-field, T-field, or R-field period Tw, Tb, Tg, or Tr, an emission intensity designation signal Cit for adjusting an emission intensity, etc. However, the emission intensity adjustment is not directly relevant to the present invention and therefore will not be elaborated upon below, assuming that the emission intensities of the light sources (i.e., the blue, green, and red LEDs 40b, 40g, and 40r) are adjusted by any well-known feature, and the light source portion control signal BCT will be described simply focusing on the field designation signal Cft.

On the basis of the field designation signal Cft, the lighting control circuit 41 controls the red, green, and blue LEDs 40r, 40g, and 40b such that the red, green, and blue LEDs 40r, 40g, and 40b emit light during the W-field period Tw, only the blue LEDs 40b emit light during the B-field period Tb, only the green LEDs 40g emit light during the G-field period Tg, and only the red LEDs 40r emit light during the R-field period Tr, as shown in FIG. 4. Note that in the present embodiment, during the W-field period, the red, green, and blue LEDs 40r, 40g, and 40b emit light in a sequential or time-division manner, thereby generating white light by virtue of temporal additive color mixing.

As described above, in the present embodiment, the data signals are applied to the data signal lines SLₗ to SLₘ, and an active scanning signal is applied sequentially to the scanning signal lines GLₗ to GLₙ, with the result that the backlight unit 40 irradiates the back of the liquid crystal panel 11 with white, blue, green, and red light sequentially for one field period each. Moreover, the common electrode 33, which is provided in common for the pixel forming portions 30 of the liquid crystal panel 11, is supplied with a predetermined voltage from an unillustrated common electrode driver circuit, and the pixel electrodes 32 and the common electrode 53 sequentially apply voltages corresponding to the white, blue, green, and red gradation signals Sw, Sb, Sg, and Sr to the liquid crystal in the pixel forming portions 30. In this manner, the voltages applied to the liquid crystal in the pixel forming portions 30 control transmittance of the white, blue, green, and red light, which irradiate the back of the liquid crystal panel 11 during the white, blue, green, and red field periods Tw, Tb, Tg, and Tr, respectively, and thereby a color image represented by the input image signal is displayed on the liquid crystal panel 11 by virtue of temporal additive color mixing.

<1.2 Functional Configuration and Operation>

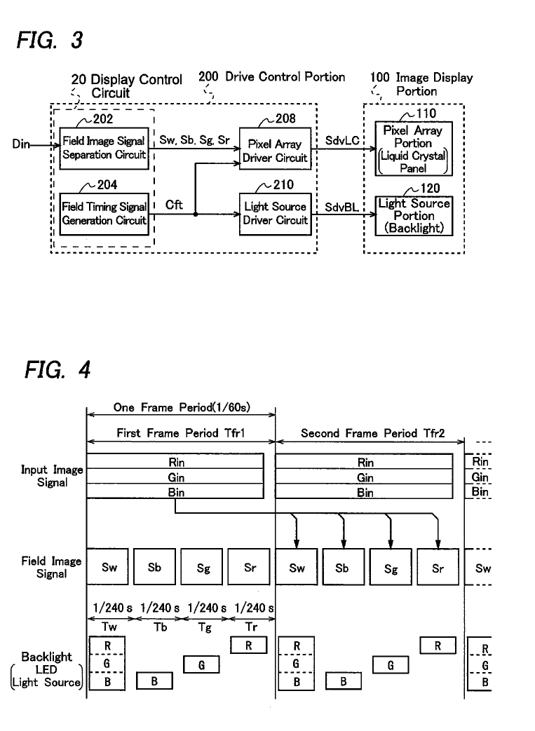

FIG. 3 is a block diagram illustrating a functional configuration of the liquid crystal display device 10 according to the present embodiment. FIG. 4 is a timing chart for describing the operation of the liquid crystal display device according to the present embodiment. The functional configuration and the operation in the present embodiment will be described below with reference to FIGS. 3 and 4.

The liquid crystal display device 10 according to the present embodiment functionally includes an image display portion 100 and the drive control portion 200, as shown in FIG. 3. The image display portion 100 includes a pixel array portion 110, which corresponds to the liquid crystal panel 11 serving as a transmissive spatial light modulation portion, and a light source portion 120, which corresponds to the backlight unit 40. The drive control portion 200 includes a field image signal separation circuit 202, a field timing signal generation circuit 204, a pixel array driver circuit. 206, and a light source driver circuit 210, and an input signal Dᵢₙ is externally provided to the field image signal separation circuit 202. Note that the field image signal separation circuit 202 and the field timing signal generation circuit 204 are implemented as components of the display control circuit 20 shown in FIG. 1. Moreover, the pixel array driver circuit 208 includes the data signal line driver circuit 18 and the scanning signal line driver circuit 17, and functions as a spatial light modulation portion driver circuit for driving the liquid crystal panel 11 serving as the pixel array portion 110. The light source driver circuit 210 corresponds to the backlight driver circuit 214 shown in FIG. 1.

In the present embodiment, each frame period is divided into four field periods Tw, Tb, Tg, and Tr, as shown in FIG. 4. Here, a frame period to be looked at for the sake of description will be referred to as a “first frame period Tfr1”, and a frame period subsequent to the first frame period will be referred to as a “second frame period Tfr2”.

The field image signal separation circuit 202 converts red, green, and red image signals Rᵢₙ, Gᵢₙ, and Rᵢₙ, which are input image signals included in an input signal Dᵢₙ externally received during the first frame period Tfr1, to white, blue, green, and red gradation signals Sw, Sb, Sg, and Sr, which are field image signals for image display during W-field, B-field, G-field, and R-field periods Tw, Tb, Tg, and Tr. The field image signals Sw, Sb, Sg, and Sr are provided to the pixel array driver circuit 208.

The field timing signal generation circuit 204 generates the field designation signal Cft, which designates W-field, B-field, G-field, and R-field periods Tw, Tb, Tg, and Tr for each frame period, and provides the field designation signal Cft to the pixel array driver circuit 208 and the light source driver circuit 210.

On the basis of the field designation signal Cft, the pixel array driver circuit 203 generates a pixel array drive signal SdvLC for driving the pixel array portion 110 (i.e., the liquid crystal panel 11) such that white, blue, green, and red images are respectively displayed during the W-field, B-field, G-field, and R-field periods Tw, Tb, Tg, and Tr. More specifically, the pixel array drive signal SdvLC is generated from the field image signals Sw, Sr, Sg, and Sb, which are generated on the basis of the input, signal Dᵢₙ during the first frame period Tfr1, and the pixel array portion 110 is driven during the second frame period Tfr2 in accordance with the pixel array drive signal SdvLC. The pixel array drive signal SdvLC corresponds to the data signals for driving the data signal lines SLₗ to SLₘ of the liquid crystal panel 11 and the scanning signals for driving the scanning signal lines GLₗ to GLₙ of the liquid crystal panel 11.

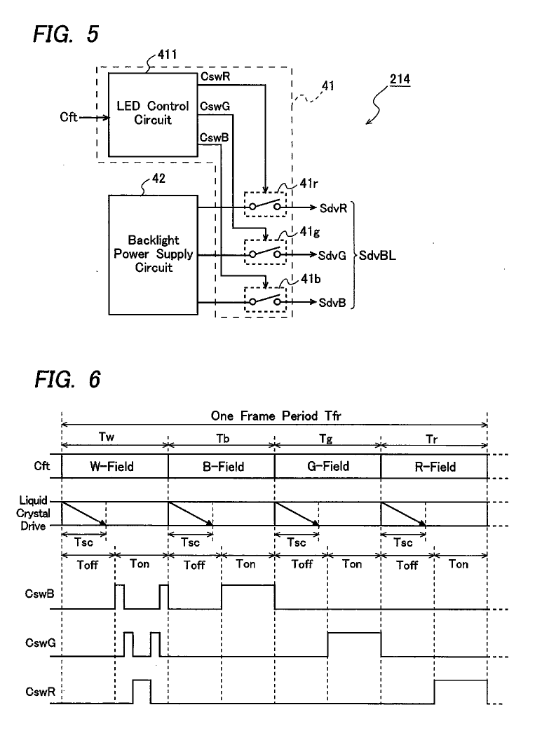

On the basis of the field designation signal Cft, the light source driver circuit 210 generates a light source drive signal SdvBL, which causes the red, green, and blue LEDs 40r, 40g, and 40b in the backlight unit 40 serving as the light source portion 120 to emit light in synchronization with the pixel array portion 110 being driven by the pixel array driver circuit 208, and the light source portion 120 is driven in accordance with the light source drive signal SdvBL. Note that as will be described later, the light source drive signal SdvBL includes a red light source drive signal SdvR, a green light source drive signal SdvG, and a blue light source drive signal SdvB (see FIG. 5).

With the above configuration, the back of the liquid crystal panel 11 serving as the pixel array portion 110 is irradiated with white, blue, green, and red light during the W-field, B-field, G-field, and R-field periods Tw, Tb, Tg, and Tr, respectively, within each frame period Tfr, and light transmittance through the liquid crystal panel 11 is controlled for each pixel by the white gradation signal Sw during the W-field period Tw, by the blue gradation signal Sb during the B-field period, by the green gradation signal Sg during the G-field period Tg, and by the red gradation signal Sr during the R-field period Tr. As a result, the white, blue, green, and red images based on the input signal Dᵢₙ are respectively displayed during the W-field, B-field, G-field, and R-field periods Tw, Tb, Tg, and Tr. Note that the white, blue, green, and red gradation signals Sw, Sb, Sg, and Sr are signals for spatially modulating the white, blue, green, and red light, respectively, on the liquid crystal panel 11, and therefore, will also be referred to as the “white modulation signal Sw”, the “blue modulation signal Sb”, the “green modulation signal Sg”, and the “red modulation signal Sr”.

<1.3 Details of Driving the Backlight Unit>

Next, details of driving the backlight unit 40 as the light source portion 120 will be described with reference to FIG. 5 to FIG. 8.

FIG. 5 is a block diagram illustrating the configuration of the backlight driver circuit. 214 serving as the light source driver circuit 210. As has already been described, the backlight driver circuit 214 includes the lighting control circuit 41 and the power supply circuit 42 for backlighting. The lighting control circuit 41 includes an LED control circuit 411, a red light source switch 41r, a green light source switch 41g, and a blue light source switch 41b, as shown in FIG. 5. The LED control circuit 411 generates red, green, and blue light source control signals CswR, CswG, and CswB on the basis of a field designation signal Cft from the field timing signal generation circuit 204, and provides the generated signals to the red, green, and blue light source switches 41r, 41g, and 41b, respectively. The red light source switch 41r is in ON state when the red light source control signal CswR is at high level (H-level) and in OFF state when the signal CswR is at low level (L-level). The green light source switch 42g is in ON state when the green light source control signal CswG is at H-level and in OFF state when the signal CswG is at L-level. The blue light source switch 41b is in ON state when the blue light source control signal CswB is at H-level and in OFF state when the signal CswB is at L-level.

The red, green, and blue LEDs 40r, 40g, and 40b in each light source unit of the backlight unit 40 are connected to the backlighting power supply circuit 42 respectively through the red, green, and blue light source switches 41r, 41g, and 41b. Accordingly, the red, green, and blue LEDs 40r, 40g, and 40b in the light source unit are provided with respective drive signals, red, green, and blue light source drive signals SdvR, SdvG, and SdvB. Therefore, in the light source unit, the red LED 40r is lit up when the red light source control signal CswR is at H-level and turned off when the signal CswR is at L-level, the green LED 40g is lit up when the green light, source control signal CswG is at H-level and turned off when the signal CswG is at L-level, and the blue LED 40b is lit up when the blue light source control signal CswB is at H-level and turned off when the signal ScwB is at L-level.

It should be noted that to render it possible to adjust the emission intensity of each LED 40x (where x=r, g, b) through pulse-width modulation, a configuration in which each light source control signal CswX (where X=R, G, B) is a pulse signal having a duty ratio in accordance with the emission intensity, instead of the light source control signal being at H-level, can be employed, but the following description is based on the assumption that such pulse-width modulation is not performed.

In the present embodiment, as shown in FIG. 6, each of the field periods Tw, Tb, Tf, and Tr is divided into first and second portions, the first portion being an OFF period T_{off} during which the backlight unit 40 does not illuminate the liquid crystal panel 11, and the second portion being an ON period Tₒₙ during which the backlight unit 40 illuminates the liquid crystal panel 11. During a scanning period Tsc included in the OFF period T_{off} within each field period Tx (where x=w, b, g, r), the pixel array driver circuit 208, which includes the data signal line driver circuit 18 and the scanning signal line driver circuit 17, scans the liquid crystal panel 11 and writes pixel data for an image represented by the gradation signal Sx to each pixel forming portion 30. The backlight driver circuit 214 selectively drives the red, green, and blue LEDs 40r, 40g, and 40b in each light source unit in accordance with the red, green, and blue light source control signals CswR, CswG, and CswB. As can be appreciated from the waveforms of the light source control signals CswR, CswG, and CswB shown in FIG. 6, only the blue LED 40b is lit up during the B-field period Tb, only the green LED 40g is lit up during the G-field period Tg, only the red LED 40r is lit up during the R-field period Tr, and the red, green, and blue LEDs 40r, 40g, and 40b are lit up sequentially (i.e., in a time-division manner) during the W-field period Tw. As a result, the back of the liquid crystal panel 11 is irradiated with white, blue, green, and red light during the W-field, B-field, G-field, and R-field periods Tw, Tb, Tg, and Tr, respectively.

In this manner, the liquid crystal panel 11 is driven (so that the pixel data is written to each pixel forming portion 30) and the backlight unit 40 is driven as well, with the result that on the basis of the input signal Dᵢₙ, white, blue, green, and red images are displayed during the W-field, B-field, G-field, and R-field periods Tw, Tb, Tg, and Tr, respectively, whereby a color image is displayed on the liquid crystal panel 11 by virtue of temporal additive color mixing.

In the present embodiment, the red, green, and blue LEDs 40r, 40g, and 40b are lit up sequentially during the ON period Tₒₙ within the W-field period Tw, as described above, and in this regard, there is a difference from the conventional configuration (FIG. 14) in which the red, green, and blue LEDs 40r, 40g, and 40b are lit up simultaneously during the W-field period. The driving of the backlight unit 40 during the W-field period Tw will be described in more detail below.

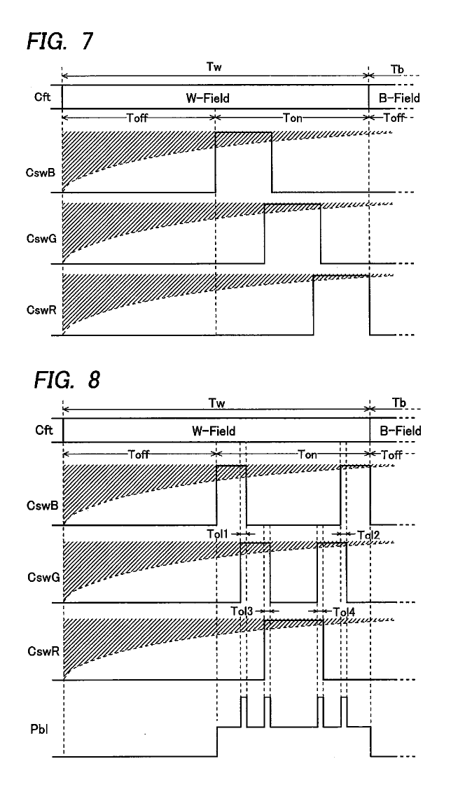

FIG. 7 is a timing chart showing a typical emission pattern along with an optical response of the liquid crystal in the liquid crystal panel 11, where the red, green, and blue LEDs 40r, 40g, and 40b in each light source unit of the backlight unit 40 are lit up sequentially during the ON period Tₒₙ within the W-field period Tw. In FIG. 7, obliquely hatched portions indicate that the amount of light from the backlight unit 40 decreases due to a transient characteristic of the optical response of the liquid crystal. More specifically, for a pulse of each of the light source control signals CswB, CswG, and CswR, the obliquely hatched portion represents a decrease in the amount of light due to the transient characteristic of the optical response (i.e., the delay in the optical response) of the liquid crystal (the same applies to FIGS. 8 to 11 to be described later).

In the case of the emission pattern shown in FIG. 7 for the light source units (i.e., the blue, green, and red LEDs 40b, 40g, and 40r) in accordance with the light source control signals CswB, CswG, and CswR, the blue LED 40b is lit up first during the ON period Tₒₙ, the green LED 40g is lit up next, and the red LED 40r is lit up last. Accordingly, the decrease in the amount of light due to the transient characteristic of the optical response of the liquid crystal is the maximum for the blue light and the minimum for the red light. Therefore, the balance is disturbed among the amounts of red, green, and blue light included in white light for white image display during the W-field period Tw. Thus, in the case of an emission pattern as shown in FIG. 7, sequentially lighting up the blue, green, and red LEDs 40b, 40g, and 40r reduces power consumption of the backlight unit 40, but color balance is disturbed owing to the transient characteristic of the optical response of the liquid crystal, resulting in reduced color reproducibility of a display image.

In the present embodiment, to inhibit such disturbance of color balance due to the transient characteristic of the optical response of the liquid crystal, two of the blue, green, and red light source control signals CswB, CswG, and CswR respectively controlling light emission of the blue, green, and red LEDs 40b, 40g, and 40r have two pulses each during the ON period Tₒₙ within each W-field period Tw, emission periods by the pulsing of the light source control signals CswB, CswG, and CswR occur symmetrically with respect to the axis of symmetry at the midpoint of the ON period Tₒₙ in the direction of time. More specifically, the LED control circuit 411 shown in FIG. 5 generates the light source control signals CswB, CswG, and CswR on the basis of the field designation signal Cft such that one of the two light source control signals has the two pulses appearing first and last during the ON period Tₒₙ within each W-field period Tw, the other light source control signal has the two pulses appearing second and second from last, and the remaining light source control signal has a pulse appearing third.

FIG. 8 shows an example of such a preferred emission pattern in the present embodiment. Specifically, emission periods by the pulsing of the light source control signals CswB, CswG, and CswR (i.e., respective emission periods of the blue, green, and red LEDs 40b, 40g, and 40r) occur symmetrically with respect to the axis of symmetry at the midpoint of the ON period Tₒₙ in the direction of time, as shown in FIG. 8, such that the blue light source control signal CswB has pulses appearing first and last during the ON period Tₒₙ within each W-field period Tw, the green light source control signal CswG has pulses appearing second and second from last, and the red light source control signal CswR has a pulse appearing third. As a result, the color of the light emitted by the backlight unit 40 during the ON period Tₒₙ within each W-field period Tw changes in the order: blue→green→red→green→blue. Considering even a small influence on color balance, it is preferred that the red LED 40r, which has the most significant influence on color balance, emits light third during the ON period Tₒₙ within each W-field period Tw, and the blue LED 40b, which has a relatively small influence on color balance, emits light first, and also last, as shown in FIG. 8. The reason for this is that humans have such a color sensitivity characteristic of readily seeing the influence of a subtle color shift, on yellowish colors, and of the colors red and green that compose yellow, red has more influence on a color shift.

As can be appreciated from FIG. 8, by configuring the above emission pattern for the blue, green, and red LEDs 40b, 40g, and 40r during each W-field period Tw, the influence of the decrease in amount of light owing to the transient characteristic of the optical response of the liquid crystal is approximately equalized among the blue, green, and red light on average, thereby inhibiting the disturbance of color balance.

Furthermore, in the present embodiment, of the pulses of the light source control signals CswB, CswG, and CswR (these pulses will also be collectively referred to below as the “emission pulses”) during the ON period Tₒₙ within each W-field period Tw, adjacent pulses overlap each other, as shown in FIG. 3. In the example shown in FIG. 8, the first pulse of the blue light source control signal CswB and the first pulse of the green light source control signal CswG overlap for a period Tol₁, the second pulse of the green light source control signal CswG and the second pulse of the blue light source control signal CswB overlap for a period Tol₂, and the first and second pulses of the green light source control signal CswG overlap the pulse of the red light source control signal CswR respectively for periods Tol₃ and Tol₄.

The reason for providing the above overlap periods (referred to below as the “emission pulse overlap periods”) Tol₁ to Tol₄ is to keep luminance decrease due to time-division light emission by the blue, green, and red LEDs 30b, 40g, and 40r from being visually recognized.

With the above emission pattern in the present embodiment, power consumption Pbl of the backlight unit 40 equals power consumed by lighting up only one LED in each light source unit, during most of the ON period Tₒₙ within each W-field period Tw, and also equals power consumed by lighting up two LEDs in each light source unit, during the emission pulse overlap periods Tol₁ to Tol₄, as shown in FIG. 8.

Here, consider an emission overlap ratio Rol as defined by the following formula:

Rol=Σ(i=1, L)Tolᵢ/Tw (1)

In formula (1), “Σ(i=1, L)Tolᵢ” represents the sum (Tol₁+Tol₂+ . . . +Tol_{L}) of Tol_{L} from i=1 to i=L, “L” denotes the number of emission pulse overlap periods per w-field period Tw, and “Tw” denotes the length of the W-field period.

From the perspective of reducing the power consumption of the backlight unit 40, the emission overlap ratio Rol is preferably “0” (i.e., emission pulses do not overlap), but when there is no overlap between emission pulses, emission luminance during the W-field period Tw (i.e., white image display luminance) decreases, as described above. On the other hand, when the emission overlap ratio Rol is increased in order to improve the emission luminance during the W-field period Tw, the power consumption of the backlight unit 40 increases. Accordingly, considering this, it is preferable to obtain an upper limit Ru of the emission overlap ratio Rol and set the emission overlap ratio Rol to be greater than “0” but less than or equal to the upper limit Ru. Therefore, in the present embodiment, the LED control circuit 411 is configured to generate the red, green, and blue light source control signals CswR, CswG, and CswB (see FIG. 5) such that the emission overlap ratio Rol during each W-field period Tw has a predetermined value that satisfies the following inequality:

0≤Rol≤Ru (2)

By employing a value of, for example, around “0.2” as the upper limit. Ru of the emission overlap ratio Rol, it is possible to suppress an increase in power consumption of the backlight unit 40 and avoid a significant decrease in emission luminance during the W-field period. However, in the case where the liquid crystal display device is used for applications or purposes for which no problem is caused by a decrease in emission luminance during the W-field period, the emission overlap ratio Rol may be set to “0” in order to prioritize decreasing power consumption.

It should be noted that the amount of light required to ensure proper white balance is not always the same among the red, green, and blue light. Accordingly, the sum of lengths of emission pulses during one frame period Tfr can be different among the red, green, and blue light, i.e., the sum of pulse lengths (i.e., pulse duration or pulse widths) can be different among the red, green, and blue light source control signals CswR, CswG, and CswB.

<1.4 Effects>

In the present embodiment as described above, the blue, green, and red LEDs 40b, 40g, and 40r emit light sequentially (i.e., in a time-division manner) during each W-field period Tw, and therefore the power consumption of the backlight unit 40 can be reduced (see the waveform of the power consumption Pbl shown in FIG. 3). Thus, in the case of the field-sequential liquid crystal display device, color breakup is prevented by setting the w-field period Tw, and the reduced power consumption during the W-field period Tw renders it possible to inhibit a cost increase due to a larger power supply circuit and a larger radiation mechanism.

In addition, in the present embodiment, the respective emission periods of the blue, green, and red LEDs 40b, 40g, and 40r occur symmetrically with respect to the axis of symmetry at the midpoint of the ON period Tₒₙ within each W-field period Tw in the direction of time (see FIG. 3), and therefore, it is possible to suppress an increase in power consumption of the backlight unit 40 and inhibit the disturbance of color balance due to the transient characteristic of the optical response of the liquid crystal, thereby maintaining satisfactory color reproducibility.

Furthermore, in the present embodiment, the red, green, and blue LEDs 40r, 40g, and 40b emit light sequentially during the ON period Tₒₙ within each W-field period Tw, in such a manner that there are overlaps between emission pulses, and the emission overlap ratio Rol is set properly (see formula (2)), whereby it is possible to suppress an increase in power consumption of the backlight unit 40 and mitigate a decrease in emission luminance during the W-field period.

### 2. Second Embodiment

Next, a field-sequential liquid crystal display device according to a second embodiment of the present, invention will be described. In this embodiment, as in the first embodiment, a color image is displayed by a field-sequential system in which one frame period is divided into four field periods Tw, Tb, Tg, and Tr, and any features other than the emission pattern during the W-field period Tw are the same as in the first embodiment (see FIGS. 1 to 5). Therefore, in the present embodiment, elements that are the same as or correspond to those in the first embodiment are denoted by the same reference characters, any detailed descriptions thereof will be omitted, and the following description will mainly focus on a configuration related to the emission pattern during the W-field period Tw.

When compared to the first embodiment, the present embodiment prioritizes ensuring a proper emission luminance (white image display luminance) during the W-field period Tw. Specifically, in the present embodiment, the LED control circuit 411 (see FIG. 5) puts no limit to overlap of pulses between two of the red, green, and blue light source control signals CswR, CswG, and CswB during the ON period Tₒₙ within each W-field period Tw, and generates the light source control signals CswR, CswG, and CswB such that the respective emission periods of the red, green, and blue LEDs 40r, 40g, and 40b occur symmetrically with respect to the axis of symmetry at the midpoint of the ON period Tₒₙ in the direction of time. More particularly, the light source control signal other than the two light source control signals has two pulses during the ON period Tₒₙ within each W-field period Tw, and these pulses appear first and last during the ON period Tₒₙ, the pulses of the two light source control signals appear second. Moreover, the ratio of the sum of periods during which pulses of two of the light source control signals CswR, CswG, and CswB overlap to the W-field period Tw, i.e., the emission overlap ratio Rol in the present embodiment, is set so as to satisfy inequality (2) above.

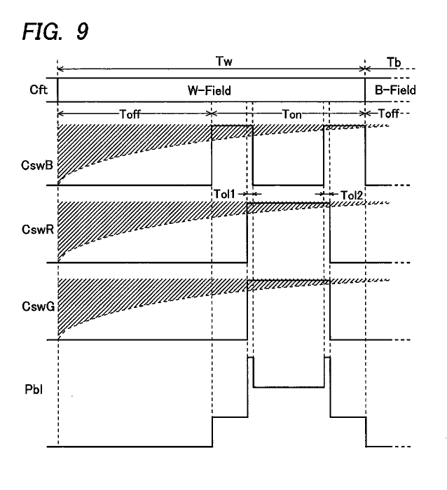

FIG. 9 shows a first emission pattern as an example of such an emission pattern in the present embodiment. In the first emission pattern, the respective emission periods of the red, green, and blue LEDs 40r, 40g, and 40b occur symmetrically with respect to the axis of symmetry at the midpoint of the ON period Tₒₙ within each W-field period Tw in the direction of time such that the pulses of the blue light source control signal CswB appear first and last during the ON period and the pulses of the red and green light source control signals CswR and CswG appear second so as to coincide with each other (i.e., both pulses have the same duration). Consequently, the color emitted by the backlight unit 40 during the ON period Tₒₙ within each W-field period Tw changes in the order: blue→red and green→blue.

As can be appreciated from FIG. 9, by configuring the above emission pattern for the blue, red, and green LEDs 40b, 40r, and 40g during each W-field period Tw, the influence of the decrease in amount of light owing to the transient characteristic of the optical response of the liquid crystal is approximately equalized among the blue, green, and red light on average, thereby inhibiting the disturbance of color-balance, as in the first embodiment (FIG. 8).

Furthermore, as shown in FIG. 9, in the first emission pattern in the present embodiment, the pulses of the red and green light source control, signals CswR and CswG completely coincide with each other during the ON period Tₒₙ within each W-field period Tw, and these pulses overlap the first pulse of the blue light source control signal CswB for a period Tol₁ and also the second pulse of the blue light source control signal CswB for a period Tol₂.

In the first emission pattern as described above, since the emission periods of the two light sources (i.e., the red and green LEDs 40r and 40g) in each light source unit coincide, as shown in FIG. 9, the power consumption Pbl of the backlight unit 40 during each W-field period Tw is greater than in the first embodiment (see FIG. 8), but the emission luminance during each W-field period Tw is higher than in the first embodiment.

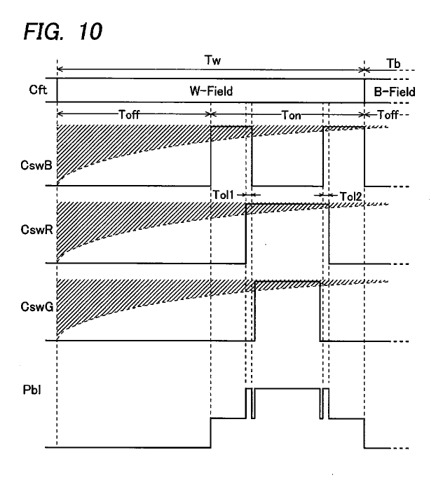

FIG. 10 shows a second emission pattern as another example of the emission pattern in the present embodiment. In the second emission pattern, during the ON period Tₒₙ within each W-field period Tw, the pulse duration of the green light source control signal CswG, i.e., the emission period of the green LED 40g, is shorter than the pulse duration of the red light source control signal CswR, i.e., the emission period of the red LED 40r, and lasts within the emission period of the red LED 40r, and the pulse duration of the green light source control signal CswG does not overlap the pulse duration of the blue light source control signal CswB, i.e., the emission period of the blue LED 40b. Other than these points, the second emission pattern has the same features as the first emission pattern.

In the second emission pattern as described above, unlike in the first emission pattern (FIG. 9) in which three emission periods overlap for the periods Tol₁ and Tol₂, only two emission periods overlap, as shown in FIG. 10. Accordingly, the power consumption Pbl of the backlight unit 40 during each W-field period Tw changes as shown in FIG. 10, and has peaks kept lower compared to the first emission pattern.

It should be noted that in the case where proper white balance is ensured by light sources such as LEDs, the amount of red light is insufficient compared to the amount of green light for the same electric power, and therefore, it is preferable to assign a longer emission period to the red light than that assigned to the green light, as shown in FIG. 10.

As described above, in the present embodiment, there is no limit to overlap in emission period between two of the blue, green, and red light (i.e., overlap in emission pulse between two colors) within each W-field period Tw (see FIGS. 9 and 10), and therefore, when compared to the first embodiment, the power consumption of the backlight unit 40 increases, but the emission luminance during the W-field period Tw (i.e., the white image display luminance) can be enhanced. In other regards, the present embodiment achieves the same effects as those achieved by the first embodiment.

### 3. Third Embodiment

Next, a field-sequential liquid crystal display device according to a third embodiment of the present invention will be described. In this embodiment, as in the first embodiment, a color image is displayed by a field-sequential system in which one frame period is divided Into four field periods Tw, Tb, Tg, and Tr, and any features other than the emission pattern during the W-field period Tw are the same as in the first embodiment (see FIGS. 1 to 5). Therefore, in the present embodiment, elements that are the same as or correspond to those in the first embodiment are denoted by the same reference characters, any detailed descriptions thereof will be omitted, and the following description will mainly focus on a configuration related to the emission pattern during the W-field period Tw.

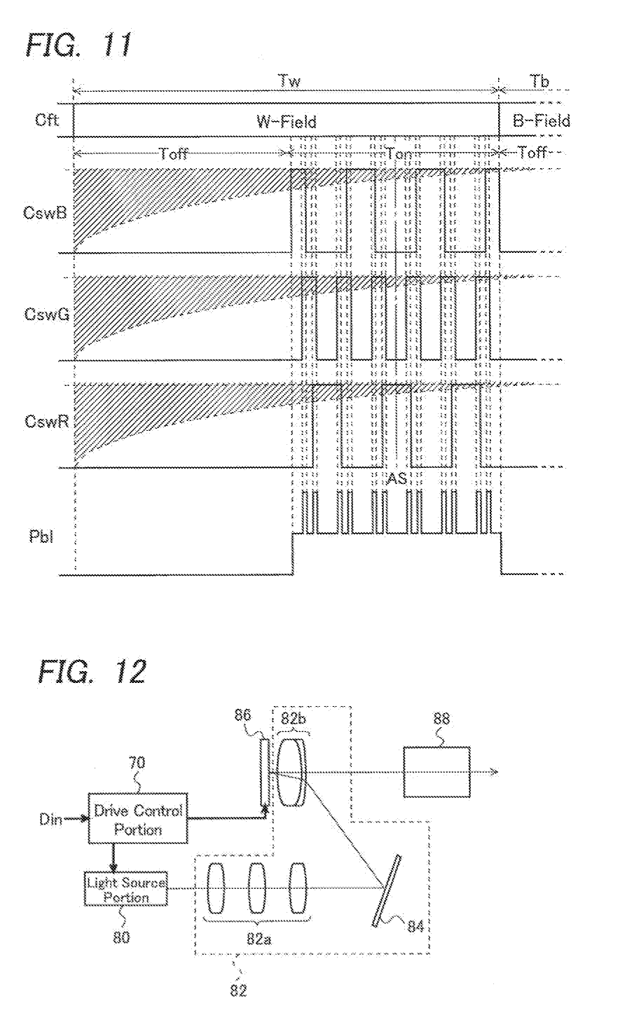

FIG. 11 is a timing chart showing an example of the emission pattern during the W-field period Tw in the present, embodiment. In the present embodiment, the LED control circuit 411 (see FIG. 5) generates the blue, green, and red light source control signals CswB, CswG, and CswR such that first-color to third-color light sources, which correspond to the blue, green, and red LEDs 40b, 40g, and 40r, emit light periodically during the ON period within each W-field period Tw, and the second-color light source (in the emission pattern in FIG. 11, the green LED 40g) emits light at twice the emission frequency of the first-color and third-color light sources (in the emission pattern in FIG. 11, the blue and red LEDs 40b and 40r). Moreover, in the present embodiment, the blue, green, and red light source control signals CswB, CswG, and CswR are generated such that the overlap period of any adjacent emission pulses (from among blue, green, and red emission pulses) of the light source control signals CswB, CswG, and CswR is shorter than half the pulse width (i.e., the pulse duration) of each of the adjacent emission pulses. As a result, the over lap between any adjacent emission periods of the blue, green, and red LEDs 40b, 40g, and 40r is shorter than a half of each of the adjacent emission periods, and overlapping of three emission periods, i.e., simultaneous light emission by the three LEDs 40b, 40g, and 40r, is avoided. Moreover, in the present embodiment, the respective emission periods of the blue, green, and red LEDs 40b, 40g, and 40r, which serve as the first to third light sources, occur symmetrically with respect to the axis of symmetry AS at the midpoint of the ON period Tₒₙ within each W-field period Tw in the direction of time such that the color of the light source that emits light first during the ON period Tₒₙ is the same as the color of the light source that emits light last, and the color of the light source that emits light second is the same as the color of the light source that emits light second from last (see FIG. 11).

In addition to achieving the same effects as those achieved by the first embodiment, the present embodiment as above increases the number of emission pulses per color during the ON period Tₒₙ within each W-field period Tw, with the result that when compared to the first embodiment, the influence of the decrease in amount of light owing to the transient characteristic of the optical response of the liquid crystal is more precisely equalized among the blue, green, and red light on average and the differences among the blue, green, and red light in terms of such influence are further diminished, whereby the disturbance of color balance is further inhibited.

Furthermore, in the emission pattern in the present embodiment, since the overlap between any adjacent emission pulses is shorter than half the pulse width of each of the adjacent emission pulses, the three LEDs (i.e., the blue, green, and red LEDs 40b, 40g, and 40r) in each light source unit do not emit light simultaneously, with the result that the power consumption of the backlight unit 40 has suppressed peaks. Consequently, the power consumption Pbl of the backlight unit 40 becomes as shown in FIG. 11. Note that in the present embodiment, as in the first embodiment, by properly setting the overlap periods of the emission pulses, it is rendered possible to put a higher priority on enhancing the emission luminance during the W-field period Tw or reducing the power consumption of the backlight unit 40, depending on the application and purpose of the liquid crystal display device.

Furthermore, in the emission pattern shown in FIG. 11, four emission periods (blue emission pulses) of the blue LED 40b, six emission periods (green emission pulses) of the green LED 40g, and three emission periods (red emission pulses) of the red LED 40r are included in the ON period Tₒₙ within each W-field period Tw, but the numbers of emission periods of the LEDs 40b, 40g, and 40r are not limited to these, and during the ON period Tw, within each W-field period Tw, the respective emission periods of the blue, green, and red LEDs 40b, 40g, and 40r are simply required to occur symmetrically with respect to the axis of symmetry AS at the midpoint of the ON period Tₒₙ in the direction of time.

### 4. Other Embodiments

In each of the above embodiments, the liquid crystal panel 11, which transmits therethrough light from the backlight unit 40 serving as the light source portion, is used as a display panel, and an image is displayed by controlling transmittance through the liquid crystal panel 11, but the present invention is not limited to field-sequential display devices using transmissive spatial light modulators such as the liquid crystal panel 11, and can also be applied to field-sequential display devices using reflective spatial light modulators. For example, the present invention can also be applied to a field-sequential projection display device using a reflective liquid crystal panel called LCOS (liquid crystal on silicon) as a spatial light modulator. FIG. 12 is a block diagram illustrating a schematic configuration of an example of such a projection display device.

As shown in FIG. 12, this projection display device includes a drive control portion 70, a light, source portion 30, a first lens group 82a which serves as a relay lens, a second lens group 82b which serves as a field lens, a mirror 84, a reflective liquid crystal panel 86 based on LCOS technology, and a projection optics system 88. The drive control portion 70 and the light source portion 80 are functionally configured to display a color image by a field-sequential system in which each frame period includes four field periods corresponding to the three primary colors, red, green, and blue, and white, as in the embodiments. However, the drive control portion 70 generates a signal controlling reflectance of reflective liquid crystal display elements on a pixel-by-pixel basis, in place of a signal controlling transmittance through the liquid crystal panel on a pixel-by-pixel basis (including the scanning control signal GCT and the data control signal SCT).

In this projection display device, the light source portion 80 is driven in the same manner as in the embodiments, and light is emitted in a color corresponding to each field period toward the first lens group 82a. The first lens group 82a, the second lens group 82b, and the mirror 84 constitute an illumination optics system 82, by which the light from the light source portion 80 forms an image on a surface of the reflective liquid crystal panel 36. In this manner, the light is guided to the reflective liquid crystal panel 86 and reflected by the reflective liquid crystal panel 86. The reflectance of the reflective liquid crystal panel 86 is controlled for each pixel in accordance with the signal from the drive control portion 70, and therefore, when light is reflected by the reflective liquid crystal panel 66, the light is spatially modulated on the basis of an image signal included in an input signal Dᵢₙ. The spatially modulated light is guided to the projection optics system 88 after returning to and passing through the second lens group, which serves as the field lens, and the projection optics system 88 projects the light onto, for example, a screen (not shown).

In such a projection display device, the emission intensity of the light source portion 80 and the reflectance of the reflective liquid crystal panel 86 are controlled in the same manner as the emission intensity of the backlight unit 40, which serves as the light source portion in the embodiments, and the transmittance through the liquid crystal panel 11 are controlled, and therefore, the same effects as those achieved by the embodiments can be achieved. Note that the projection display device uses a reflective liquid crystal panel as a spatial light modulator, but in place of this, another reflective spatial light modulator such as a DMD (digital micromirror device; registered trademark) element may be used,

### 5. Variants

The present invention is not limited to the above embodiments, and various modifications can be made without departing from the scope of the invention.

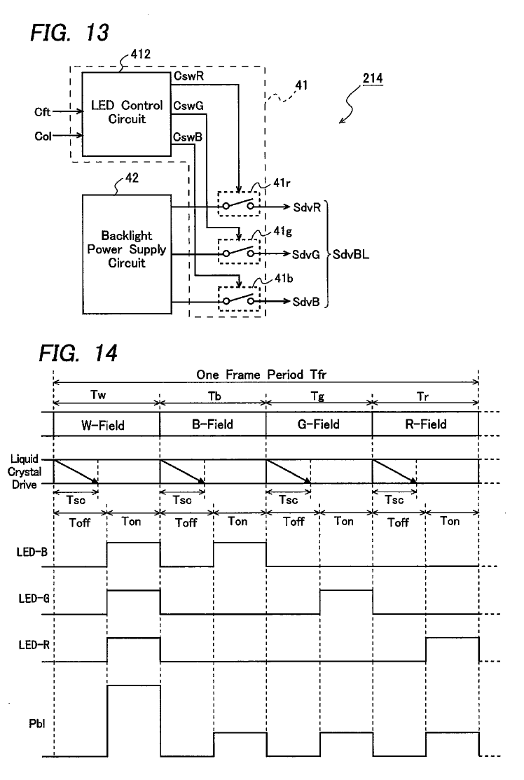

For example, in the embodiments, the emission overlap ratio Rol (formula (1), which indicates the ratio of a period during which any two emission pulses overlap to the ON period Tₒₙ within the W-field period Tw is set in advance to a given value that satisfies inequality (2), but the emission overlap ratio Rol may be changed within the range indicated by inequality (2). FIG. 13 is a block diagram illustrating the configuration of a backlight driver circuit 214 in such a variant. The backlight driver circuit 214 includes a lighting control circuit 41 as in the embodiments, and the lighting control circuit 41 includes an LED control circuit 412 for generating red, green, and blue light source control signals CswR, CswG, and CswB. The LED control circuit 412 receives an overlap ratio control signal Col, which indicates an emission overlap ratio Rol, and the light source control signals CswR, CswG, and CswB are generated such that emission pulses overlap in accordance with the overlap ratio control signal Col (e.g., emission pulse overlap periods Tolᵢ are equal in length). Here, the overlap ratio control signal Col may be externally inputted to the liquid crystal display device or may be generated in accordance with an operation on a predetermined operating portion provided in the liquid crystal display device. The variant as above renders it possible to adjust the emission pulse overlap periods in accordance with the overlap ratio control signal Col and thereby change priority between enhancing the emission luminance during the W-field period Tw and reducing the power consumption of the backlight unit 40, depending on the application and purpose of the liquid crystal display device.

Furthermore, the embodiments employ the field-sequential system in which each frame period includes four field periods respectively corresponding to the four colors, white, blue, green, and red, but the present invention is not limited to such a configuration and can be applied to any field-sequential systems so long as each frame period includes a predetermined number of field periods respectively corresponding to a predetermined number of colors, including white, provided that the predetermined number is four or more. Moreover, in the embodiments, the backlight unit 40 emits light during the W-field period generally in the order: blue→green→red, but the order of colors to be emitted is not necessarily limited to this.

It should be noted that in the embodiments, LEDs are used as light sources, but organic EL (electroluminescent) elements, cold-cathode tubes, etc., may be used instead. Moreover, in the embodiments, the three types of light sources (the red, green and blue LEDs 40r, 40g, and 40b) corresponding to the three primary colors, red, green, and blue, are used, but three types of light sources corresponding to another combination of three primary colors may be used.

### 6. Other

This application claims priority to Japanese Patent. Application No. 2016-058416, filed Mar. 23, 2016 and titled “COLOR IMAGE DISPLAY DEVICE AND COLOR IMAGE DISPLAY METHOD”, the content of which is incorporated herein by reference. DESCRIPTION OF THE REFERENCE CHARACTERS

10 liquid crystal display device

11 liquid crystal panel (spatial light modulation portion)

17 scanning signal line driver circuit

18 data signal line driver circuit

20 display control circuit

30 pixel forming portion

40 backlight unit (light source portion)

41 lighting control circuit

40r red LED (red light source)

40g green LED (green light source)

40b blue LED (blue light source)

80 light source portion

86 reflective liquid crystal panel (spatial light modulation portion)

110 pixel array portion

120 light source portion

200 drive control portion

202 field image signal separation circuit

204 field timing signal generation circuit

208 pixel array driver circuit (spatial light modulation portion driver circuit)

210 light source driver circuit

214 backlight driver circuit (light source driver circuit)

411, 412 LED control circuit

Sw white gradation signal (white modulation signal)

Sr red gradation signal (red modulation signal)

Sg green gradation signal (green modulation signal)

Sb blue gradation signal (blue modulation signal)

Tfr frame period

Tw W-field period (white field period)

Tr R-field period (red field period)

Tg G-field period (green field period)

Tb B-field period (blue field period)

Tₒₙ ON period

T_{off} OFF period

Cft field designation signal

CswR red light source control signal

CswG green light source control signal

CswB blue light source control signal

BCT light source portion control signal

SdvBL light, source drive signal

1. A color image display device of a field-sequential system with each frame period including a predetermined number of field periods respectively corresponding to a predetermined number of colors including white, the predetermined number being four or more, the device comprising:
a light source portion including first to third light sources respectively emitting light in first to third colors constituting three primary colors;
a spatial light modulation portion configured to transmit or reflect light from the light source portion;
a light source driver circuit configured to selectively drive the first to third light sources so as to obtain light in colors respectively corresponding to the predetermined number of field periods during the respective field periods; and
a spatial light modulation portion driver circuit configured to control transmittance through or reflectance of the spatial light modulation portion such that images are displayed in the colors respectively corresponding to the predetermined number of field periods during the respective field periods, wherein,
the light source driver circuit drives the first to third light sources such that at least two of the first to third light sources emit light sequentially during a white field period being one of the predetermined number of field periods and corresponding to white.

2. The color image display device according to claim 1, wherein the light source driver circuit drives the first to third light sources such that respective emission periods of the first to third light sources occur symmetrically in a direction of time during a predetermined period within the white field period.

3. The color image display device according to claim 1, wherein the light source driver circuit drives the first to third light sources such that the first to third light sources emit light sequentially during the white field period.

4. The color image display device according to claim 1, wherein the light source driver circuit drives the first to third light sources such that adjacent emission periods of the first to third light sources overlap during the white field period.

5. The color image display device according to claim 4, wherein the light source driver circuit drives the first to third light sources such that the overlapping of the adjacent emission periods of the first to third light sources during the white field period is shorter than a half of each of the adjacent emission periods.

6. The color image display device according to claim 4, wherein an emission overlap ratio is defined as a ratio of a sum of periods during which the adjacent emission periods overlap to the white field period and the emission overlap ratio is greater than zero but less than or equal to a predetermined upper limit.

7. The color image display device according to claim 6, wherein the emission overlap ratio is approximately less than or equal to 20%.

8. The color image display device according to claim 2, wherein the spatial light modulation portion is a liquid crystal panel.

9. The color image display device according to claim 1, wherein,
the three primary colors are red, green, and blue, and
the light source driver circuit drives the first to third light sources such that during the white field period, a blue-light emission period occurs first and a green-light emission period occurs second.

10. The color image display device according to claim 2, wherein the light source driver circuit drives the first to third light sources such that emission periods of two of the first to third light sources coincide with each other during the white field period or the emission period of one of the two light sources includes the emission period of the other light source.

11. A color image display method for a color image display device to display an image by a field-sequential system with each frame period including a predetermined number of field periods respectively corresponding to a predetermined number of colors including white, the predetermined number being four or more, the device including a light source portion including first to third light sources respectively emitting light in first to third colors constituting three primary colors, and a spatial light modulation portion configured to transmit or reflect light from the light source portion, the method comprising:
a light source driving step of selectively driving the first to third light sources so as to obtain light in colors respectively corresponding to the predetermined number of field periods during the respective field periods; and
a spatial light modulation portion driving step of controlling transmittance through or reflectance of the spatial light modulation portion such that images are displayed in the colors respectively corresponding to the predetermined number of field periods during the respective field periods, wherein,
in the light source driving step, the first to third light sources are driven such that at least two of the first to third light sources emit light sequentially during a white field period being one of the predetermined number of field periods and corresponding to white.

12. The color image display method according to claim 11, wherein in the light source driving step, the first to third light sources are driven such that respective emission periods of the first to third light sources occur symmetrically in a direction of time during a predetermined period within the white field period.

13. The color image display method according to claim 11, wherein in the light source driving step, the first to third light sources are driven such that adjacent emission periods of the first to third light sources overlap during the white field period.

14. The color image display device according to claim 1, wherein the light source driver circuit drives the first to third light sources such that the first to third light sources emit light sequentially during the white field period.

15. The color image display device according to claim 1, wherein the light source driver circuit drives the first to third light sources such that adjacent emission periods of the first to third light sources overlap during the white field period.

16. The color image display device according to claim 15, wherein the light source driver circuit drives the first to third light sources such that the overlapping of the adjacent emission periods of the first to third light sources during the white field period is shorter than a half of each of the adjacent emission periods.

17. The color image display device according to claim 15, wherein an emission overlap ratio is defined as a ratio of a sum of periods during which the adjacent emission periods overlap to the white field period and the emission overlap ratio is greater than zero but less than or equal to a predetermined upper limit.

18. The color image display device according to claim 17, wherein the emission overlap ratio is approximately less than or equal to 20%.

19. The color image display device according to claim 1, wherein,
the three primary colors are red, green, and blue, and
the light source driver circuit drives the first to third light sources such that during the white field period, a blue-light emission period occurs first and a green-light emission period occurs second.

20. The color image display device according to claim 1, wherein the light source driver circuit drives the first to third light sources such that emission periods of two of the first to third light sources coincide with each other during the white field period or the emission period of one of the two light sources includes the emission period of the other light source.
